(19) United States
(12) Patent Application Publication
(10) Pub. No.: US 2006/0092482 A1
(43) Pub. Date: May 4, 2006

(54) Solid-state image pickup apparatus with error due to the characteristic of its output circuit corrected

(75) Inventors: Takashi Yano, Asaka-shi (JP); Atsuhiko Ishihara, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fuji Photo Film Co., Ltd., Kanagawa (JP)

(21) Appl. No.: 11/259,276

(22) Filed: Oct. 27, 2005

(30) Foreign Application Priority Data
Oct. 28, 2004 (JP) 2004-313452
Sep. 29, 2005 (JP) 2005-283902

(51) Int. Cl. H04N 1/04

(52) U.S. Cl. 358/482

(57) ABSTRACT

A solid-state image pickup apparatus includes an image sensor having its photosensitive array divided into sections. Image signals are respectively output from the divided sections via corresponding output amplifiers as image signals representative of a field picked up and then processed by corresponding preamplifiers. Valid pixel data representative of the field picked up and correction information data representative of stepwise quantities of light are respectively produced from a valid and a correction pixel region, which constitute the photosensitive array, in each of the divided sections. The valid image pixel data are corrected by the correction information data. The valid image data thus corrected in plural are combined to constitute a single image signal.

### BACKGROUND OF THE INVENTION

1. Field of the Invention

The present invention relates to a solid-state image pickup apparatus, and more particularly to a solid-state image pickup apparatus of the type reading out signal charges from a solid-state image sensor having its photosensitive array divided into plural sections.

2. Description of the Background Art

Conventional solid-state image pickup apparatuses include one of the type having its photosensitive array divided into a plurality of sections for outputting image signals representative of a field picked up in the form of plural streams of signal derived from the photosensitive sections via respective output amplifiers, and processing each image signal stream with a particular preamplifier, which includes a correlated double sampling (CDS) circuit.

An image pickup apparatus of the type described has a problem that, because the respective image signals are processed by corresponding amplifiers, there occurs, e.g., a difference in amplifier gain ascribable to the characteristic of each amplifier. For example, FIG. 2 shows how a specific difference occurs between the outputs of a plurality of CDS circuits. Further, FIG. 3 shows how a specific difference occurs when the outputs of the CDS circuits each are digitized by a particular analog-to-digital (A/D) converter for linearity correction. Such differences are ascribable not only to the characteristic of each CDS circuit or that of each A/D converter but also to the characteristic of a floating diffusion amplifier (FDA) or similar preamplifier involved.

In light of the above, Japanese patent laid-open publication No. 2004-88190, for example, discloses a camera system including an image sensor made up of an imaging section divided into a plurality of blocks in the horizontal direction and amplifiers assigned to the corresponding blocks. First, the camera system is operated to shoot a predetermined and dedicated subject for correction having a gradation pattern in which the quantity of incident light is uniform in the horizontal direction, but varies in the vertical direction in a predetermined rate.

Gradation data included in the result of the above shot and derived from at least the arrays of pixels adjoining the boundaries between the blocks of the imaging section are used to produce, block by block, cumulative histograms on the number of events in the respective tones. Subsequently, correction data representative of correspondence between non-corrected and corrected tones are generated in order to reduce differences between the above cumulative histograms. The correction data thus generated are used to correct the result of actual pickup of a desired subject.

Another prior art document, Japanese patent application No. 203313/1995, proposes a solid-state image pickup apparatus including a first and a second floating diffusion amplifier for transducing signal charges generated by optical signals input to photo-sensors to a signal voltage. Signal voltages thus generated are amplified to a desired voltage level by a first and a second preamplifier, and then double-sampled by a first and a second CDS circuit. The mean value of the resulting analog video signals is constantly controlled to a predetermined value by a first and a second video level control circuits. Consequently, a difference in signal voltage ascribable to differences in characteristic between the floating diffusion amplifiers and between the preamplifiers is corrected.

Further, U.S. patent application publication No. 2003/0209651 A1 to Iwasaki teaches a light-receiving device in which pixels are formed by a stack of a first light-receiving part that senses a green beam of light while transmitting a blue and a red beam of light, a second light-receiving par that senses the blue beam of light while transmitting the red beam of light, and a third light-receiving part that senses the red beam of light. The first, second and third light-receiving parts are formed of an organic photoconductor.

A problem with the camera system disclosed in Japanese patent laid-open publication No. 2004-88190 mentioned earlier is that the subject dedicated for correction must be shot at the time of delivery from a factory of the camera or before the actual shot of a desired subject, resulting in the need for a large-scale studio and inefficient operation. Another problem is that even with correction data derived from such a shot for correction, it is impossible to attain the expected effect when the characteristic of the amplifier is varied in dependence upon its ambient temperature.

The image pickup apparatus taught in Japanese patent application No. 203313/1995 also mentioned earlier executes correction in accordance with the mean value of the outputs of amplifiers, and is therefore unable to correct the linearity of the image sensor and amplifiers although successfully correcting its gain.

### SUMMARY OF THE INVENTION

It is an object of the present invention to provide a solid-state image pickup apparatus capable of correcting a difference between a plurality of image signals output therefrom and passing through corresponding amplifiers.

It is a more specific object of the present invention to provide a solid-state image pickup apparatus of the type outputting a plurality of image signals, derived from a corresponding plurality of divided section, via respective output amplifiers and preamplifiers with an error due to the characteristic of the output amplifiers and preamplifiers minimized, thus being capable of reducing discontinuity of the image signals, particularly capable of obviating the influence of temperature to effectively correct irregularity in linearity including gain and offset.

A solid-state image pickup apparatus of the present invention includes an image sensor for outputting an image signal with pixels formed by photo-sensors for photoelectric conversion arranged in rows and columns to constitute a photosensitive array, which is divided into a plurality of sections in a horizontal direction or a vertical direction, and signal processing circuitry for processing the image signal. The image sensor includes a plurality of output circuits each for transferring and outputting the respective image signal generated in particular one of the divided sections via a vertical transfer path or a horizontal transfer path. Each of the plurality of output circuits is configured to output particular one of a plurality of valid image signals representative of a field picked up by the photosensitive array and derived from particular one of the plurality of divided sections, and configured to output a plurality of correction information signals generated in corresponding one of the divided sections. The photosensitive array produces signal levels each corresponding to a predetermined quantity of light incident thereto. Each of the correction information signals is representative of particular one of a plurality of stepwise quantities of incident light.

The signal processing circuitry includes a plurality of divided signal processors each being assigned to particular one of the divided sections for executing analog processing on the valid information signal and correction information signal derived from the same divided section, and then converting a processed analog signal to a digital signal. A digital signal processor also included in the signal processing circuitry receives a plurality of digital valid image signals and a plurality of digital correction information signals from the plurality of divided signal processing circuits to produce a single digital image signal from the plurality of valid image signals, and further executes digital signal processing on the single digital image signal. The digital signal processor includes a correcting circuit for correcting, before the production of the single digital image signal, the plurality of valid image signals with the plurality of correction information signals.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of the solid-state image pickup apparatus in accordance with the present invention;

FIG. 2 is a graph plotting specific outputs of two CDS circuits included in the illustrative embodiment, each being representative of the quantity of light incident to a particular divided section of the photosensitive array;

FIG. 3 is a graph plotting curves each being representative of the linearity based on the quantity of light incident to a particular divided section;

FIG. 4 is a block diagram schematically showing an alternative embodiment of the present invention;

FIG. 5 is a timing chart useful for understanding a specific operation of the embodiment of FIG. 4;

FIG. 6 is a block diagram schematically showing another alternative embodiment of the present invention;

FIG. 7 is a graph showing specific outputs of two CDS circuits included in the embodiment of FIG. 6, each being representative of the quantity of light incident to a particular divided section of the photosensitive array;

FIG. 8 is a plan view showing the photosensitive array included in still another alternative embodiment of the present invention as seen from its light incidence side;

FIG. 9 is a plan view showing the photosensitive array included in yet another alternative embodiment of the present invention as seen from its light incidence side;

FIG. 10 conceptually shows the section of a photosensitive cell included in a further alternative embodiment of the present invention as seen from its light incidence side;

FIG. 11 is a partly cut way, perspective view showing an additional embodiment of the present invention; and

FIG. 12 is a conceptual sectional view illustrating a photosensitive cell included in another additional embodiment of the present invention.

### DESCRIPTION OF THE PREFERRED EMBODIMENTS

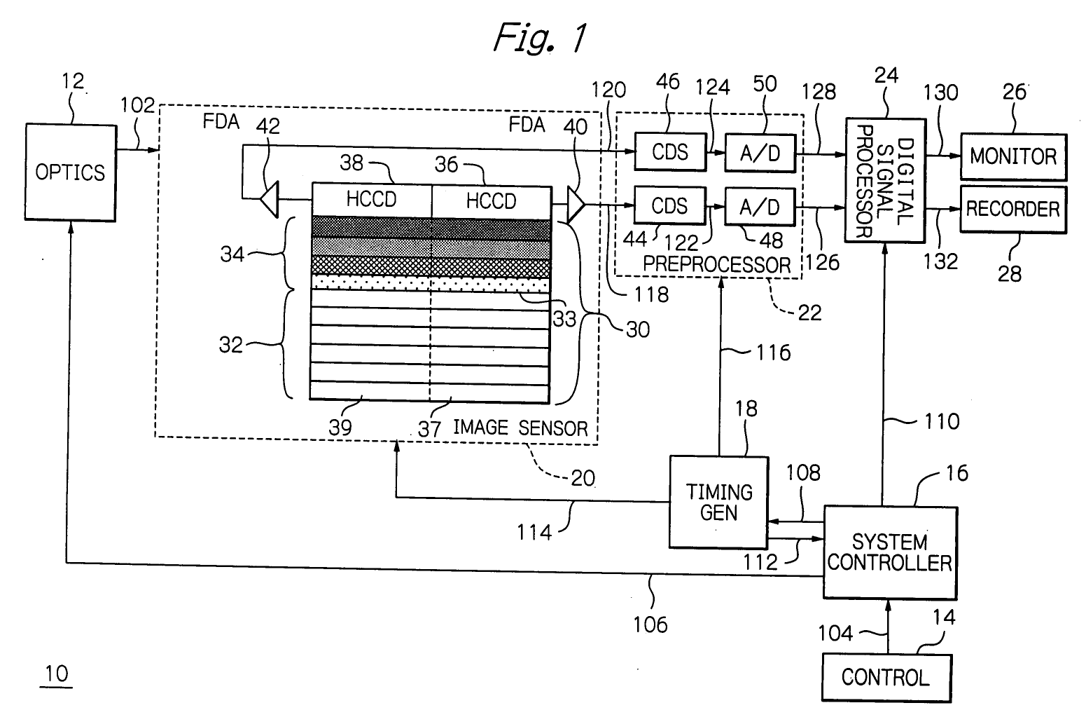

Referring to FIG. 1 of the accompanying drawings, a solid-state image pickup apparatus embodying the present invention, generally 10, is a camera in which a light beam representative of a desired field is input to optics 12, and the manipulation of a control panel 14 mounted on the apparatus 10 causes a system controller 16 and a timing generator 18 to control various circuits included in the apparatus 10 to capture the image representative of the desired field by an image sensor 20 to sequentially process a signal of the image thus captured by a preprocessor 22 and a digital signal processor 24 so as to display the resultant digital image signal on a monitor 26 and record it in a recorder 28. It is to be noted that components of the apparatus 10 not directly relevant to the understanding of the present invention are not shown and will not be described specifically in order to avoid redundancy.

More specifically, with reference to FIG. 1, the image sensor 20 has its photosensitive array 30 divided into a plurality of sections 37 and 39 and outputs the image signal representative of the image of a desired field via a plurality of output amplifiers 40 and 42 in the form of a corresponding plurality of image'signals derived from the divided sections 37 and 39. Also, the photosensitive array 30 comprises a valid pixel region 32 and a correction pixel region 34. The correction pixel region 34 is provided with a film, not shown, having its optical transmissivity varying in level stepwise in the vertical direction of the image screen formed by the array 30, thus capable of outputting a signal in a gradation pattern.

The preprocessor 22, as shown in FIG. 1, includes a plurality of preamplifiers, e.g., CDS circuits 44 and 46 each for processing an analog electric signal output from one of the output amplifiers 40 and 42 connected thereto. The electric signals thus processed by the CDS circuits 44 and 46 are converted to digital signals by analog-to-digital (A/D) converters 48 and 50, respectively.

The optics 12 may have a conventional configuration including lenses, an iris control mechanism, a shutter mechanism, a zoom mechanism, an automatic focus (AF) control mechanism and an automatic exposure (AE) control mechanism, although not shown specifically. The optics 12 constitutes a light receiving mechanism which is controlled by a control signal 106 output from the system controller 16 to drive the iris control, shutter, zoom and AF control mechanisms to pick up a desired field and cause the resulting imagewise light to be incident on the photosensitive array 30 of the image sensor 20. In the description to follow, signals are designated with reference numerals attached to connections on which they appear.

The control panel 14 allows the operator of the apparatus 10 to input desired information and commands and feeds an operation signal 104 to the system controller 16. The operation signal 104 is representative of operator's manual operation, e.g., the stroke of a shutter release button, not shown, depressed by the operator.

The system controller 16 is adapted to control the operation of the entire apparatus 20 in response to the operation signal 104 input thereto from the control panel 12. In the illustrative embodiment, the system controller 16 is configured to send control signals 106, 108 and 110 to the optics 12, timing generator 18 and digital signal processor 24, respectively, in response to the operation signal 104.

The timing generator 18 includes an oscillator for generating a system or basic clock 112 essential for the operation of the apparatus 10. The system clock 112 is fed to the system controller 16 in response to the control signal 108. Further, the timing generator 18 delivers the system clock 112 to most of the constituent blocks of the apparatus 10 while dividing the frequency of the system clock 112, although not shown in FIG. 1 specifically, to produce various timing signals.

Moreover, in the illustrative embodiment, the timing signal generator 18 generates timing signals in response to the control signal 108 fed from the system controller 16. The timing signals include timing signals 114 including a vertical and a horizontal synchronizing signal and an electronic shutter pulse and delivered to the image sensor 20. Further, the timing signal generator 16 generates timing signals 116 including sampling pulses for correlated double sampling and a conversion clock signal for analog-to-digital conversion.

In the illustrative embodiment, the image sensor 20 has the function of transducing imagewise light representative of a desired field incident on its photosensitive array 30 to a corresponding analog electric signal to conduct the electric signal to a plurality of, e.g., two, HCCD (Horizontal Charge Coupled Device) registers 36 and 38 and the corresponding plurality of output amplifiers 40 and 42 mentioned earlier to output the analog electric signal in the form of corresponding plural streams of analog electric signals 118 and 120. In the illustrative embodiment, the image sensor 20 may be implemented by any one of conventional image sensors including a CCD (Charge-Coupled Device) image sensor and a MOS (Metal-Oxide Semiconductor) image sensor. In short, the photosensitive array 20 is virtually partitioned to include the left ant right portions in FIG. 1. The partitioning is implemented by the two HCCD registers 36 and 38, as will later be described in detail.

The photosensitive array 30 may be implemented by an array of CCD photosensitive cells constituting a single frame of image including a plurality of pixels. Each of the pixels is formed by a photodiode or similar photo-sensitive device configured to photoelectrically convert light incident thereon to an electric signal corresponding to the quantity of the incident light. The pixels are arranged in matrix which being provided with red (R), green (G) and blue (B) color filter with the illustrative embodiment.

In the illustrative embodiment, the valid pixel region 32, forming part of the photosensitive array 30, constitutes one frame of image picked up while the correction pixel region 34, forming the other part of the above array 30, produces correction information for correcting the image picked up. The image sensor 20, therefore, outputs two analog electric signals each containing both of valid image data and correction information data generated by the two regions 32 and 34, respectively.

The correction pixel region 34 is positioned at one side, near the upper end with the illustrative embodiment, of the photosensitive array 30. The correction pixel region 34 is configured to receive the incident light by the pixels arranged in the quantity which is even in the direction parallel to its boundary 33 against the valid pixel region 32, i.e., in the horizontal direction of the array 20.

In the illustrative embodiment, the correction pixel region 34 has its light-input surface covered with a film having its optical transmissivity varying or graded stepwise in the direction perpendicular to its boundary 33 against the valid pixel region 32 but uniform in the horizontal direction. This film may be formed of, e.g., aluminum for forming an optical black (OB) region or may be implemented by a color filter. Thus, the above film has the same transmissivity in the horizontal direction and has a plurality of transmissivities different in level in the vertical direction, so that the correction pixel region 34 is capable of conveying a gradation pattern of incident light via the film to the underneath region of the photosensitive cell array 30.

For example, the correction pixel region 34 of the illustrative embodiment is configured such that the longer the distance from the valid pixel region 32 the lower the transmissivity of the film is, in other words, the shorter the distance from the valid pixel region 32 the higher the transmissivity. While the film of the correction pixel region 34 is shown with a variety of hatchings in the form of stripes as having its optical transmissivity varying in four consecutive steps in the vertical direction in FIG. 1, the transmissivity may be varied in five or more steps when more accurate linearity correction is desired.

In the illustrative embodiment, a plurality of VCCD (Vertical CCD) registers, not shown, may be arranged on the photosensitive array 30, and each is connected to either one of the plurality of HCCD registers 36 and 38. In other words, each of the HCCD registers 36 and 38 maybe connected to particular VCCD registers corresponding in position thereto. For example, as shown in FIG. 1, when the photosensitive array 30 is divided into two sections 37 and 39 in the vertical direction, the HCCD registers 36 and 38 may be respectively connected to VCCD registers positioned at the right and left sections 37 and 39, as seen in FIG. 1, of the photosensitive array 30.

In the illustrative embodiment, the image sensor 20 photoelectrically transforms, under the control of the timing signals 114, light 102 incident thereto to signal charges pixel by pixel and transfers the signal charges to the HCCD registers 36 and 38 via corresponding VCCD registers. The HCCD registers 36 and 38, in turn, transfer the signal charges received from the VCCD registers to the output amplifiers 40 and 42, respectively. The output amplifiers 40 and 42 respectively convert the signal charges input from the HCCD registers 36 and 38 to the analog electric signals 118 and 120 mentioned previously, and may be implemented by, but not limited to, an floating diffusion amplifier each.

In FIG. 1, the image sensor 20 is shown as including a plurality of HCCD registers 36 and 38 that transfer signal charges in such a manner as to divide an image on the photosensitive array 30 into two in the horizontal direction. Alternatively, the apparatus may be structured such that an image on the photosensitive array 30 is divided in the vertical direction, in which case the correction pixel region 34 will be provided with a film having its optical transmissivity different in level stepwise in the horizontal direction.

The preprocessor 22 is under the control of the timing signals 116, and has preamplifiers executing analog signal processing on the corresponding analog electric signals 118 and 120. More specifically, in the illustrative embodiment, the CDS circuits 44 and 46 execute correlated double sampling on the analog electric signals 118 and 120, respectively, in order to cancel noise components. Subsequently, the A/D converters 48 and 50 respectively convert signals 122 and 124 output from the CDS circuits 44 and 46 to corresponding digital image signals or data 126 and 128. Alternatively, the preprocessor 22 maybe configured, if desired, such that another analog signal processor, not shown, processes the signals 122 and 124 with gain-controlled amplifiers (GCAs) and feeds the resulting signals to the A/D converters 48 and 50.

The digital signal processor 24 is adapted to execute, in response to the control signal 110 output from the system controller 16, digital signal processing on the digital image signals 126 and 128 input from the A/D converters 48 and 50, respectively. Particularly, in the illustrative embodiment, the digital signal processor 24 is configured to correct valid image data with correction information data contained in each of the digital image signals 126 and 128. For example, the digital signal processor 24 may correct each valid image data with correction information derived from a difference between the two correction information data.

Further, the digital signal processor 24 applies digital signal processing to one frame of image represented by the digital image signals 126 and 128 corrected by the above procedure, thereby producing a single digital image signal. The digital image signal thus output from the digital signal processor 24 is input to the monitor 26 and recorder 28 as signals 130 and 132, respectively.

The monitor 26 serves as displaying an image represented by the digital image signal 130 fed from the digital signal processor 24, and may be implemented by a liquid crystal display (LCD) panel by way of example. The recorder 28 for storing the digital image signal 132 may be configured to record, e.g., a compressed image signal in a memory card loaded with a semiconductor memory device or a package accommodating a magnetooptical disk or similar spinning type of recording medium.

In operation, when the operator of the apparatus 10 depresses the shutter release button of the control panel 14, an operation signal 104 representative of an image shoot command is fed from the control panel 14 to the system controller 16.

In response to the operation signal 104, the system controller 16 sends control signals 106 and 108 representative of the shoot command to the optics 12 and timing generator 18, respectively. The timing signal generator 18 generates timing signals 112, 114 and 116 representative of a photometry command in response to the control signal 108, and delivers the timing signals 112, 114 and 116 to the system controller 16, image sensor 20 and preprocessor 22, respectively.

In the optics 12, the light 102 input from a desired field is incident on the image sensor 20 in a predetermined or controlled quantity, so that an image representative of the field is focused on the photosensitive array 30. The resulting signal charges generated and stored in the pixels or photosensitive cells of the array 30 are read out in response to the control signal 114. Consequently, a signal level corresponding to the predetermined or controlled quantity of light is attained. In the illustrative embodiment, signal charges read out from the pixels at the right section 37, as seen in FIG. 1, of the photosensitive array 30 are transferred via the HCCD register 36 and floating diffusion amplifier 40 to be converted to an analog electric signal 118. Likewise, signal charges read out from the pixels at the left section 39, as seen in FIG. 1, of the photosensitive array 30 are transferred via the HCCD register 38 and floating diffusion amplifier 42 to be converted to an analog electric signal 120.

More specifically, in the correction pixel region 34, the light 102 is incident via the film having its transmissivity different from each other, so that the quantity of incident light is different in dependence upon the thus graded transmissivity. Consequently, correction information data dependent upon the plurality of stepwise signal levels are output from the correction pixel region 34. Therefore, the analog electric signals 118 and 120 each contain not only valid image data representative of the image picked up but also the correction information data thus involving the stepwise gradation mentioned above.

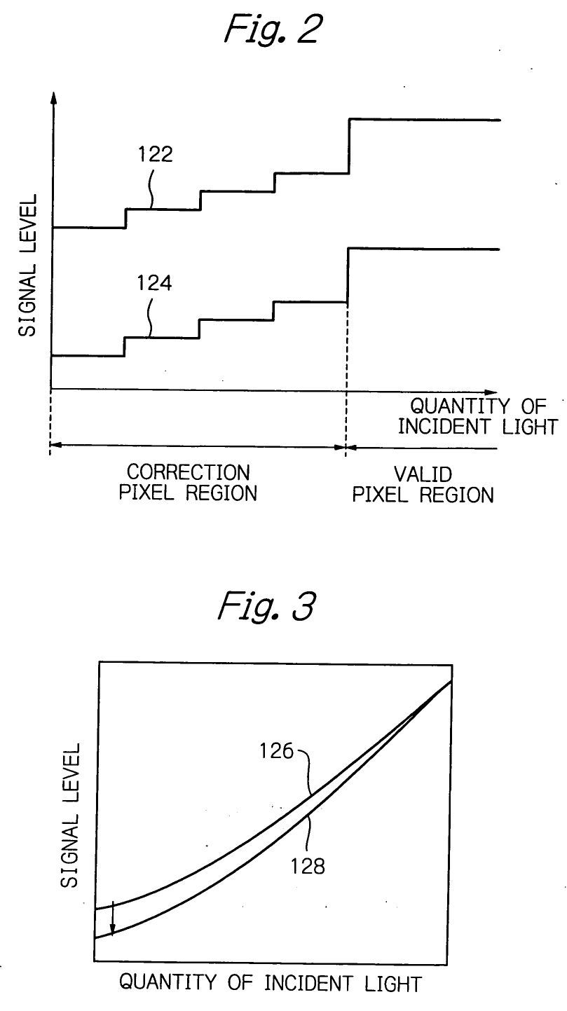

The analog electric signals 118 and 120 are in turn input to the preprocessor 22. The preprocessor 22 preprocesses the input electric signals 118 and 120 with the respective preamplifiers in response to the timing signal 116. More specifically, in the preprocessor 22, the CDS circuits 44 and 46 respectively executes correlated double sampling on the electric signals 118 and 120 for thereby generating CDS output signals 122 and 124. At this instant, as shown in FIG. 2, the correction information data, contained in each of the CDS output signals 122 and 124, are represented by the four signal levels varying stepwise due to the four different transmissivities of the correction pixel region 34 varying stepwise in the vertical direction. The CDS output signals 122 and 124 are respectively input to the A/D converters 48 and 50 and converted to digital image signals 126 and 128 thereby.

FIG. 3 shows curves representative of the signal levels of the correction information data, which are contained in the digital image signals 126 and 128, appearing when the above data are subjected to linearity correction. In FIG. 3, the ordinate and abscissa indicate the signal level and the position of a correction pixel, i.e., the quantity of input light, respectively. As shown in the example, the correction information data contained in the digital image signal 128 is lower in signal level, i.e., output darker than the correction information data contained in the digital image signal 126. The difference between the digital image signals 126 and 128 is ascribable to the output characteristics of the floating diffusion amplifiers 40 and 42, CDS circuits 44 and 46 and A/D converters 48 and 50 having processed the image signals, and a difference also occurs not only in amplifier gain but also in linearity.

Upon receiving the digital image signals 126 and 128 from the preprocessor 22, the digital signal processor 24 corrects differences between the individual valid image data. In the illustrative embodiment, the digital signal processor 24 makes the level of the lighter digital image signal 126 match to the level of the darker digital image signal 128, thereby producing correction information based on the image signal 126 lower in signal level than the image signal 128. The signal processor 24 then performs an operation on the valid image data and the above correction information to correct the valid image data of the digital image signal 126.

More specifically, the digital signal processor 24, having attained the linearity correction information shown in FIG. 3 from the correction information data of the digital image signals 126 and 128, detects a plurality of subject signal levels out of the linearity correction information of the image signal 126. The plurality of subject signal levels may be detected in accordance with the stepwise-changing or graded transmissivity of the film covering the correction pixel region 34, i.e., with each of the quantities of incident light derived from the stepwise transmissivity. Alternatively, the subject signal levels may be detected at predetermined intervals of the quantity of incident light or of signal level.

It is preferable to detect, as reference signal levels, the linearity correction information of the digital image signal 128 each being positioned on the same quantity of incident light as a particular subject signal level, and then calculate a difference between each reference signal level and the corresponding subject signal level as correction information. If desired, correction information may be produced by dividing a reference signal level by a subject signal level.

Further, the digital signal processor 24 detects, out of a plurality of subject signal levels, a subject signal level close to the signal level of the individual signal, and then performs an operation with the subject signal level and correction information corresponding to the detected subject signal level, thereby correcting the valid image data of the digital image signal 126 to an adequate level.

Subsequently, the digital signal processor 24 combines the digital image signals 126 and 128 to form one frame of digital image signal and then executes other digital signal processing for thereby generating a single digital image signal.

The digital image signal thus processed by the digital signal processor 24 is transferred to the LCD panel or similar monitor 26 in the form of digital image signal 130 for displaying thereon, and also to the recorder 28 in the form of digital image signal 132 for recording, in response to the control signal 110, which is output from the system controller 14 and indicative of image display and storage.

Reference will now be made to FIG. 4 for describing an alternative embodiment of the present invention. As shown, this alternative embodiment includes a storage time controller 60, instead of the film covering the correction pixel region 34 of the photosensitive array 30 for outputting the gradation pattern in the embodiment described with reference to FIG. 1. The same function as the film is implemented by the storage time controller with the alternative embodiment. The storage time controller 60 provides the pixels or photosensitive cells of the correction pixel region 34 with particular signal charge storage periods of time for thereby implementing the correction information data having the signal level thereof varying stepwise as with the film employed by the embodiment described with reference to FIG. 1.

In this alternative embodiment, the storage time controller 60 feeds the VCCD registers, not shown but described earlier, with read pulses for controlling the timing for reading out signal charges stored in the individual pixels or cells of the photosensitive array 30. More specifically, the VCCD registers include a plurality of gate electrodes, not shown, which are controlled to allow signal charges stored in pixels arranged in the horizontal direction to be read out at the same timing, whereas the storage time controller 60 feeds read pulses at a timing that is different between the electrodes lying in the correction pixel region 34 and those lying in the valid pixel region 32.

In more detail, the storage time controller 60 reads out a signal charge over a period of time that varies in accordance with the position thereof in the direction perpendicular to the boundary 33 between the valid pixel region 32 and the correction pixel region 34. For example, in the storage time controller 60, the signal charge storage time is set longer in the valid pixel range 32 and shorter in the correction pixel range 34 stepwise as the distance from the valid pixel range 32 increases.

Further, the correction pixel region 34 is divided into a plurality of zones in the vertical direction. The storage time controller 60 feeds the electrodes lying in the same zone with read pulses at the same timing while the electrodes lying in the different zones with read pulses at the correspondingly different timings. In this alternative embodiment, as shown in FIG. 4, the correction pixel region 34 is divided into four stripe zones S1, S2, S3 and S4. However, the correction pixel region 34 maybe divided, when more accurate linearity correction is desired, into five or more zones, from which signal charges are read out after the storage periods of time different between those zones. The storage time controller 60 feeds pulses 202, 204, 206 and 208 to the four zones S1, S2, S3 and S4, respectively, while feeding read pulses 210 to the valid pixel region 32 in a usual manner.

It is to be noted that in this alternative embodiment all the pixels of the correction pixel region 34 may have the transmissivity thereof equal to each other, which may be the same as the pixels or photo sensitive cells of the valid pixel region 32, as desired.

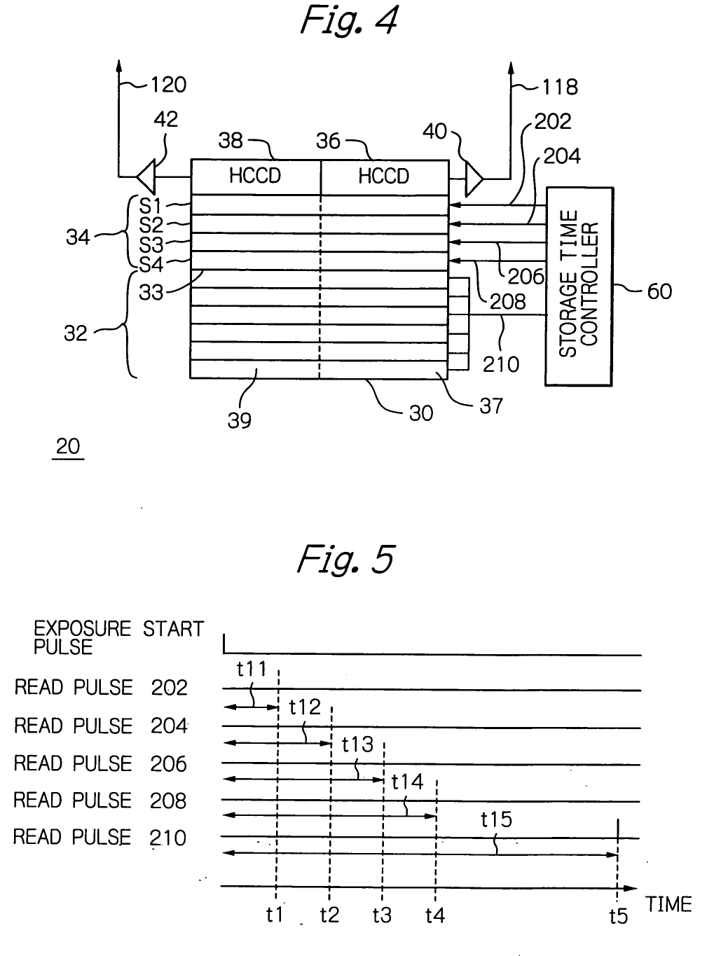

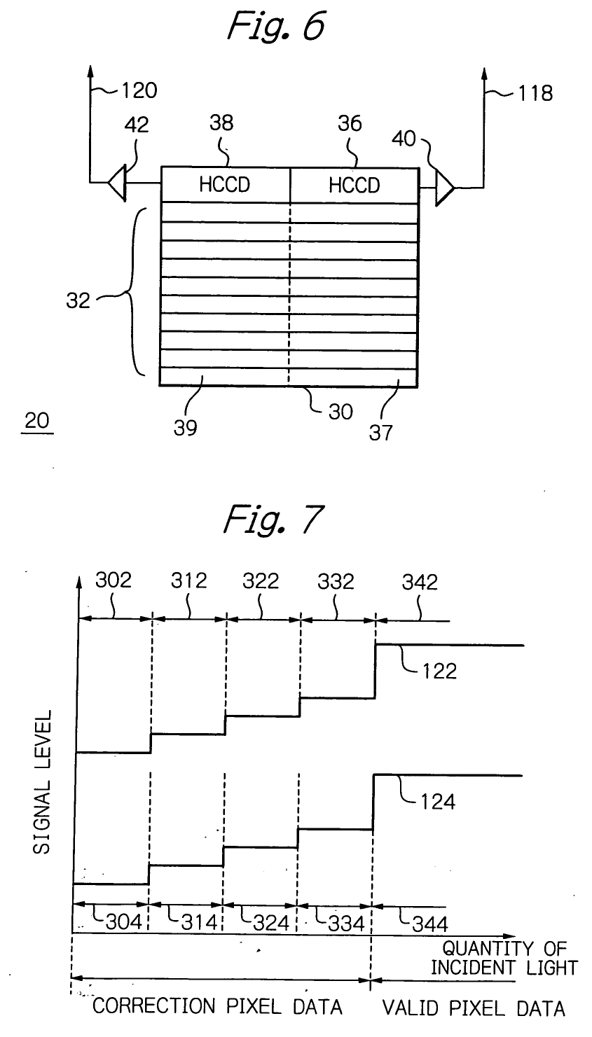

FIG. 5 demonstrates a specific operation of the storage time controller 60. As shown, after the start of exposure of the photosensitive array 30, the storage time controller 60 feeds the read pulse 202, which is oscillated at a time t1, to the zone S1 of the correction pixel region 34 for thereby reading out signal charges from the zone S1 over the shortest storage time t11. Subsequently, the controller 60 feeds the read pulses 204, 206 and 208, which are respectively oscillated at times t2, t3 and t4, to the zones S2, S3 and S4, respectively, of the correction pixel region 34 for thereby reading out signal charges over storage times t12, t13 and t14 that increase stepwise in this order. Finally, the controller 60 feeds a read pulse 210, which oscillates at a time t5, to the valid pixel region 32 for thereby reading signal charges over the longest storage time t15.

As stated above, by varying or controlling the quantity of light of signal charge to be read out between the zones of the correction pixel region 34, this alternative embodiment makes the storage time shorter as the distance from the valid pixel range 32 increases i.e., longer as the distance decreases. This also implements the CDS output having gradation, as shown in FIG. 2. Further, by digitizing the CDS output and correcting its linearity, it is possible to produce correction information data, e.g., data shown in FIG. 3 and then produce, based on the correction information data, correction information for correcting the individual signal levels.

The storage time controller 60 may alternatively be configured to feed overflow drain (OFD) signals or similar reset signals instead of read pulses in order to control the timing for resetting unnecessary charges in the valid pixel region 32 and correction pixel region 34. More specifically, the controller 60 may feed reset signals 202, 204, 206 and 208 to the consecutive zones S1, S2, S3 and S4 of the correction pixel region 34, respectively, and feed a reset signal 210 to the valid pixel region 32.

When the storage time controller 60 is configured to feed the reset pulses, as stated above, signal charges are read out with the image sensor 20 performing the following operation. After the start of exposure, the reset signal 210 oscillating first removes unnecessary charges from the pixels of the valid image region 32. Subsequently, the reset signal 208 oscillates to remove unnecessary charges from the zone S4 of the correction pixel region 34. Likewise, the reset signals 206, 204 and 202 sequentially oscillate in this order to remove unnecessary charges from the other zones S3, S2 and S1 of the correction pixel region 34, respectively.

As stated above, by controlling the timing of the reset signals, the storage time controller 60 is capable of controlling the storage time of signal charges in the valid pixel region 32 and correction pixel region 34, and therefore attaining CDS outputs having gradation, e.g., one shown in FIG. 2.

In practice, it is impractical to shoot a subject uniform over the entire frame. In light of this, considering that the quantities of incident light around the boundary 33 between the valid pixel region 32 and the correction pixel region 34 are equal, this alternative embodiment may adapted to use the signal level of pixels around the boundary 33 to generate the correction information data.

Another alternative embodiment of the present invention will be described hereinafter. In this alternative embodiment, the system controller 16 causes a shutter, not shown, included in the shutter mechanism to close for storing a dark current generated in the light-intercepted condition in the individual pixels or cells, causes signal charges constituted by the dark current to be read out from the pixels, and then produce an image signal having a predetermined signal level corresponding to the storage time. The system controller 16 causes such storage and read-out to be repeated several times while varying the storage time, thereby generating an image signal having a plurality of stepwise signal levels. With this scheme, too, it is possible to generate correction information data having a plurality of stepwise signal levels, e.g., one shown in FIG. 2.

In this alternative embodiment, as shown in FIG. 6, the photo sensitive array 30 of the image sensor 20 may be entirely constituted by the valid image region 32. In addition, when light is intercepted as stated above, the signal levels of all pixels constituting one frame may be used to generate correction information data.

More specifically, in this alternative embodiment, signal charges stored in the pixels of the photosensitive array 30 over the shortest period of time and constituted by the dark current are read out with the shutter being held in the closed position. The signal charges thus read out are delivered to the preprocessor 22 via the HCCD registers 36 and 38 and output amplifiers 40 and 42, and then fed from the preprocessor 22 to the digital signal processor 24. As a result, corrected image signals 302 and 304, see FIG. 7, each corresponding to one of the divided sections 37 and 39 are generated and may preferably be written to, e.g., a memory, now shown.

Subsequently, the image pickup apparatus 10 operates with the shutter being continuously closed but with the storage time of the charges in the photosensitive array 30 being extended stepwise, so that the signal charges, also constituted by the dark current, are repeatedly read out from the pixels. Those signal charges are also delivered to the digital signal processor 24 via the HCCD registers 36 and 38, output amplifiers 40 and 42 and preprocessor 22. Consequently, the digital signal processor 24 sequentially outputs corrected image signals 312, and 314, 322 and 324 and 332 and 334, see FIG. 7. These corrected image signals 312 and 314 through 332 and 334 may also be written to a memory, not shown, in combination.

After the procedure described above, the system controller 16 causes the shutter to open for starting an actual pickup. At this instant, signal charges, constituted by a light current or saturation conductance, are read out from the pixels of the photosensitive array 30, and then delivered to the digital signal processor 24 via the HCCD registers 36 and 38, output amplifiers 40 and 42 and preprocessor 22. Consequently, the digital signal processor. 24 generates digital image signals 342 and 344, FIG. 7, each corresponding to particular one of the divided sections 37 and 39 of the image sensor 20.

When the digital image signals 342 and 344 thus generated by the digital signal processor 24 are combined with the corrected image signals 302 and 304 through 332 and 334, respectively, signals 352 and 354, shown in FIG. 7, each having a particular gradation pattern are produced. The gradation pattern signals 352 and 354 are subjected to linearity correction by the digital signal processor 24 with the result that correction information data represented by, e.g., the curves shown in FIG. 3 are attained. Therefore, correction information for correcting the individual signal levels can be produced on the basis of the correction information data.

This alternative embodiment may be modified such that the digital image signals 342 and 344 generated at the time of actual pickup are not combined but the correction image signals 302 and 304 through 332 and 334 are exclusively combined to generate the gradation pattern signals 352 and 354. This can be done if, e.g., the gradation pattern signals 352 and 354 are generated before an actual pickup and then subjected to linearity correction to thereby produce correction information for correcting the individual signal levels. In this manner, correction information for correcting the individual signal levels can be prepared before an actual pickup.

The crux of this alternative embodiment is applicable to the image sensor 20 shown in FIG. 4 including the storage time controller 60. In this case, too, a dark current generated when the shutter is closed, i.e., in a light-intercepted condition is stored in the individual pixels or cells, and then signal charges constituted by the dark current are read out to generate correction information data. At this instant, the storage time controller 60 assigns a particular storage period of time to each zone of the correction pixel region 34 and reads out signal charges constituted by the dark current to thereby produce correction information data having a plurality of signal levels varying stepwise, as shown in FIG. 2. In this configuration, the transfer of signal charges from the VCCD registers to the HCCD registers 36 and 38 should only be effected one time. Further, the correction information data may alternatively be generated by use of the signal levels of all pixels in the horizontal direction because the correction pixel region 34 is shielded.

The crux of this alternative embodiment is also applicable even to the image sensor 20 shown in FIG. 1 including the film having a particular transmissivity assigned to each zone of the correction pixel region 34. Again, a dark current generated when the shutter is closed, i.e., in a light-intercepted condition is stored in the individual pixels, and then signal charges constituted by the dark current are read out to generate correction information data. In this case, because incident light is input to the individual pixels via the above film having the graded transmissivity, correction information data having a plurality of signal levels varying stepwise, as shown in FIG. 2, can be produced only if stored signal charges comprised of the dark current are read out over the same storage time. Again, the transfer of signal charges from the VCCD registers to the HCCD registers 36 and 38 should only be effected one time. Further with the embodiment, because the correction pixel region 34 is optically shielded to the graded extent, the signal levels of all pixels in the horizontal direction may alternatively be used to generate the correction information data.

Furthermore, with the embodiment including the correction pixel section 34 having the stepwise transmissivity different from zone to zone as described above, not only signal charges constituted by a dark current but also signal charges constituted by a light current generated when the shutter is opened may be read out so as to render it possible to attain correction information data in levels twice as many as the number of the steps of transmissivity of the film, i.e., the number of zones of the correction image region 34. This successfully renders linearity correction more accurate.

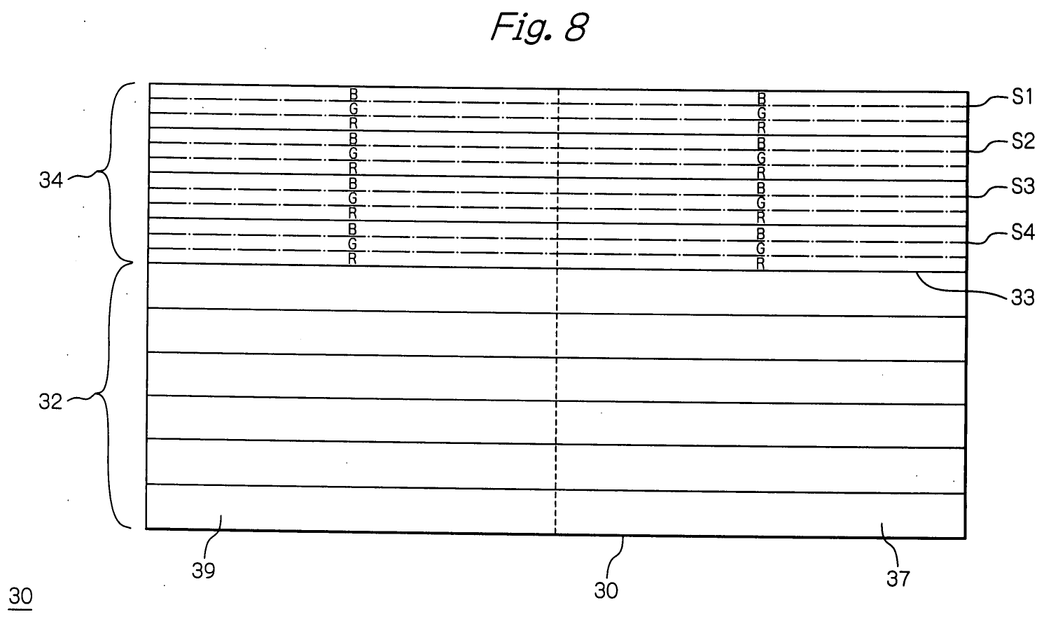

Still another alternative embodiment of the present invention practicable with the photosensitive array 30 of FIG. 1 or 4 will be described with reference to FIG. 8. This alternative embodiment produces color data representative of any one of a plurality of colors from each pixel not only in the valid pixel region 32 but also in the correction pixel region 34, and then produces, in each divided section 37 or 39 of the correction pixel region 34, a plurality of stepwise signal levels based on the color of the above color data, thereby generating correction information data color by color. This configuration allows valid image data derived from each divided section 37 or 39 of the valid pixel region 32 to be corrected by the correction information data color by color.

The color data output from the pixels of the photosensitive array 30 may be primary color data, i.e., R, G and B data or complementary color data.

More specifically, in this alternative embodiment, the correction pixel region 34 is made up of four zones S1, S2; S3 and S4 divided in parallel to the boundary 33 between the valid pixel region 32 and the correction pixel region 34. In the correction pixel region 34, photosensitive cells or pixels are arranged in each of the zones S1 through S4 such that, without regard to the arrangement of color pixels in the valid pixel region 32, color data of the same color are produced in the direction parallel to the boundary 33 mentioned above, i.e., in the horizontal direction while color data of different colors are produced in the direction perpendicular to the boundary 33, i.e., in the vertical direction. While red pixels R, green pixels G and blue pixels B for producing red data, green data and blue data, respectively, are sequentially arranged in this order in each of the zones S1 through S4, as seen from the valid pixel region 32, such an arrangement of color pixels is only illustrative.

For example, in the zone S1 of the configuration shown in FIG. 8, a red pixel signal level, a green pixel signal level and a blue pixel signal level are produced from a row of red pixels R, a row of green pixels G and a row of blue pixels B, respectively.

Assume that the photosensitive array 30 shown in FIG. 8 is applied to the image sensor 20 shown in FIG. 1. Then, transmissivity is lowest in the zone S1 of the correction image region 34 and sequentially increases in the zones S2, S3 and S4 stepwise in this order. It follows that the red, green and blue pixel signal levels are lowest in the zone S1 and sequentially increase stepwise in the zones S2, S3 and S4 in this order. Such pixel signal levels varying stepwise are attainable in each of the divided sections S1 through S4 of the photosensitive array 30.

Likewise, when the photosensitive array 30 shown in FIG. 8 is applied to the image sensor 20 shown in FIG. 4, the signal charge storage time is shortest in the zone S1 of the correction pixel region 34 and sequentially increases stepwise in the zones S2, S3 and S4 in this order. Consequently, the red, green and blue pixel signal levels are lowest in the zone S1 and sequentially increase in the zones S2, S3 and S4 stepwise in this order.

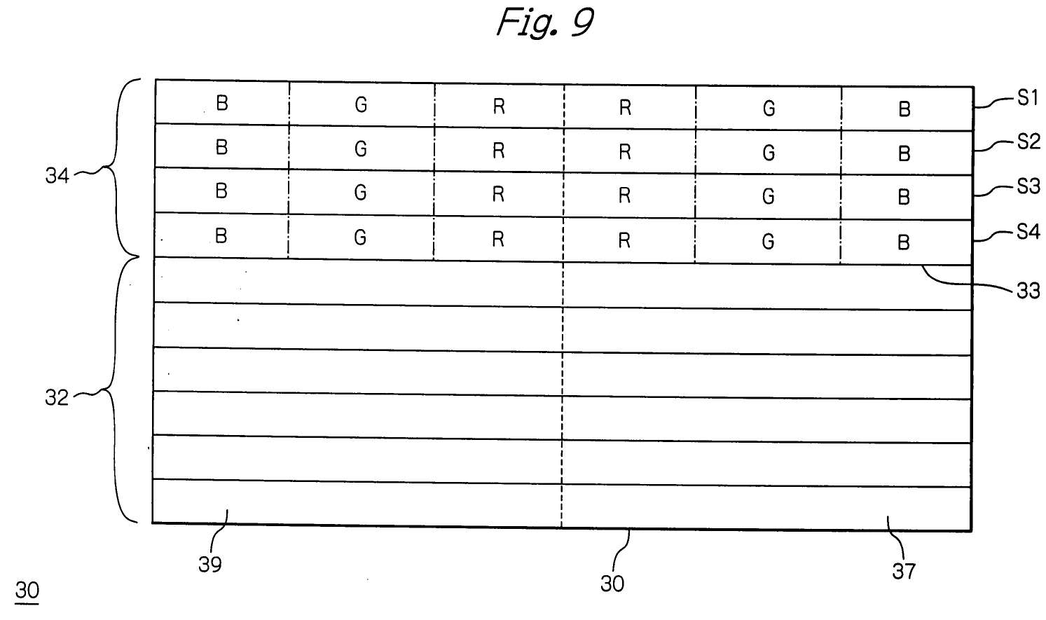

FIG. 9 shows a further alternative embodiment of the present invention. As shown, in the correction pixel region 34 of the photosensitive array 30, color data of the same color are produced from the zones S1 through S4 in the vertical direction while color data of different colors are produced in the horizontal direction without regard to the arrangement of colors in the valid pixel region 32. In this alternative embodiment, red, green and blue pixels R, G and B for producing red, green and blue data, respectively, are sequentially arranged in this order from a position closest to the boundary 33 between the divided sections 32 and 34 of the photosensitive array 30. In that case, from the zone S1, for example, the plurality of pixels or photosensitive cells included in each horizontal line develop such signal levels that red, green and blue pixel signal levels are arranged in this order. Of course, such an order is only illustrative and maybe varied, as desired.

In this alternative embodiment, to produce color data representative of any one of the different colors from each pixel of the correction pixel region 34, each pixel may be provided with a color filter so as to implement a plurality of stepwise signal levels color by color for thereby generating correction image data color by color.

For example, the pixels of the correction pixel region 34 each may be provided with a red, a green or a blue primary color filter that transmits red, green or blue light, respectively, for thereby producing R, G and B color data. The R, G and B or primary color filters may be replaced with complementary color filters, if desired.

It follows that, in this alternative embodiment, the R, G and B pixels, constituting the correction pixel region 34 of the photosensitive array 30, may be provided with R, G and B filter segments, respectively.

Further, in this alternative embodiment, to produce color data of any one of a plurality of colors from each pixel of the correction pixel region 34, each pixel may be implemented by a photoelectric transducer film or photosensor that absorbs light of a predetermined color to thereby generate a corresponding signal charge. In this case, a plurality of signal levels varying stepwise are produced from each photoelectric transducer film of the respective color for thereby generating correction information data. Such a photoelectric transducer film should preferably be provided on each pixel of the valid pixel region 32 also in addition to the correction pixel section 34 of the photosensitive array 30.

The photoelectric-transducer film is constituted by an organic polymer and organic pigment uniformly dispersed in the polymer. The organic pigment absorbs a component of light having a predetermined wavelength to thereby generate a signal charge to be transported in the polymer. More specifically, on the photosensitive array 30, the photoelectric transducer film is sandwiched between two electrodes and causes the pigment uniformly dispersed in the polymer to absorb a specific light component for thereby generating a corresponding electric charge. In this condition, a voltage is applied between the above electrodes to cause the polymer to transport the charge.

Further, the photoelectric transducer film may be provided with a single pigment layer/inorganic base spectral amplification film, nanoparticle thin film or similar photosensitive layer instead of a thin organic film stated above. For example, in this alternative embodiment, each pixel of the photosensitive array 30 may be provided with any one of a red, a green and a blue photoelectric transducer film that absorb red, green and blue light, respectively, so as to produce red, green and blue color data. Again, the red, green and blue photoelectric transducer films may be replaced with films of complementary colors.

It is therefore possible to stack one or more kinds of photoelectric transducer films in one or more layers to form R, G and B pixels on the photosensitive array of FIG. 8.

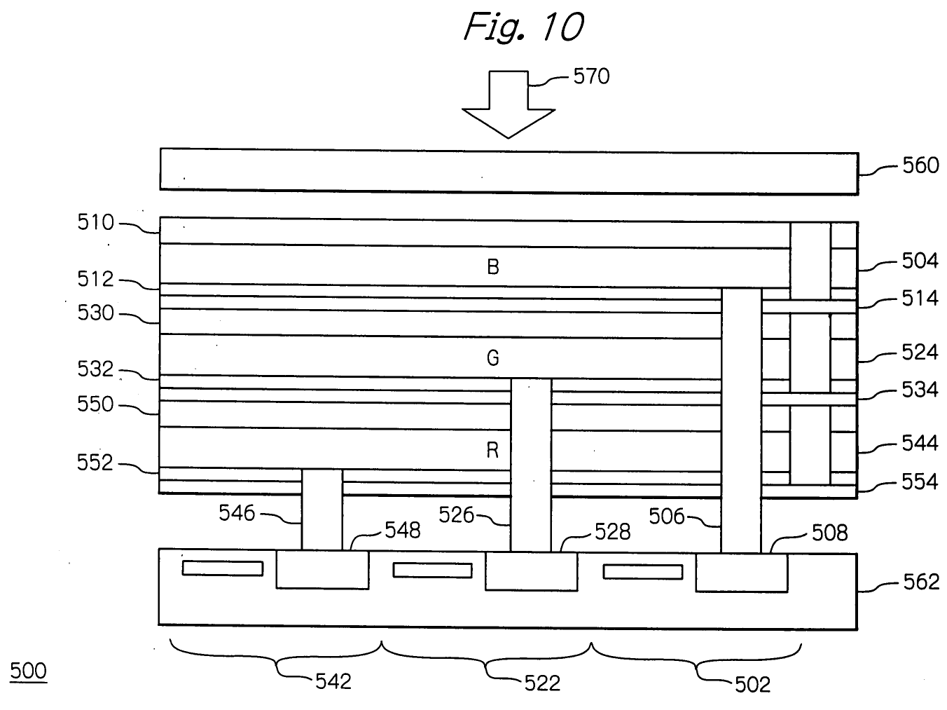

FIG. 10 shows a specific photosensitive array 500 having a stack of three photoelectric conversion layers, e.g., a blue, a green and a red photosensitive layer 504, 524 and 544 implemented by a blue, a green and a red absorbing film, respectively. The blue photosensitive layer 504 is sandwiched between a blue and a blue facing electrode 510 and 512. Likewise, the green photosensitive layer 524 is sandwiched between a green and a green facing electrode 530 and 532, while the red photosensitive layer 544 is sandwiched between a red and a red facing electrode 550 and 552.

An insulation layer 514 is positioned between the blue facing electrode 512 and the green pixel electrode 530. Likewise, insulation layers 534 and 554 are respectively positioned between the green facing electrode 532 and the red pixel electrode 550 and between the red facing electrode 552 and a substrate not shown.

Further, a blue, a green and a red pixel 502, 522 and 544 are arranged on the photosensitive array 500. The blue pixel 502 is configured such that a charge, generated in the blue photosensitive layer 504, is transferred to a blue charge storage 508 via a blue pixel contact 506. Also, in the green pixel 522, a charge, generated in the green photosensitive layer 524 is transferred to a green pixel storage 528 via a green pixel contact 526 while in the red pixel 544 a charge, generated in the red photosensitive layer 544, is transferred to a red charge storage 548 via a red pixel contact 546. It should be noted that although a great number of pixels are, in practice, arranged on the photosensitive array 500, FIG. 10 shows only the blue pixel 502, green pixel 522 and red pixel 544 for the simplicity of illustration.

The blue, green and red charge storages 508, 528 and 548, respectively, are formed on the semiconductor substrate such as silicon substrate 562, and configured to transfer the charges stored therein by a charge transferring section, which is also formed on the substrate in a similar way to the charge storage sections.

How the photosensitive array 500 with the structure shown in FIG. 10 responds to light 570 incident thereto will be described hereinafter. As shown, the light 570 is input to the blue photosensitive layer 504 via a cover glass or similar protection film 560. In response, the blue photosensitive layer 504 absorbs a blue component contained in the light 570 with the result that a signal charge corresponding to the blue component is generated and transferred to the blue charge storage 508 via the blue pixel contact 506.

Subsequently, part of the light 570, transmitted through the blue photoconductive layer 504, is incident to the green photosensitive layer 524. In response, the green photosensitive layer 524 absorbs a green component also contained in the part of the light 570 with the result that a signal charge associated with the green component is generated and transferred to the green charge storage 528 via the green pixel contact 526.

Remaining part of the light 570, transmitted through the green photoconductive layer 524, is incident to the red photosensitive layer 544. In response, the red photosensitive layer 544 absorbs a red component contained in that part of the light 570 with the result that a signal charge corresponding to the red component is generated and transferred to the red charge storage 548 via the red pixel contact 546.

The signal charges thus stored in the charge storages 508, 528 and 548 are read out to the charge transfer path 562 and then transferred vertically and horizontally in a way used by CCD or MOS system. Particularly, in this alternative embodiment, the charges are delivered to the plurality of amplifiers 40 and 42 and converted to the plurality of analog electric signals 118 and 120 thereby, as shown in FIG. 1. Because the analog electric signals 118 and 120 each contain data output not only from the valid pixel region 32 but also from the correction pixel region 34, there are produced correction information data of three primary colors.

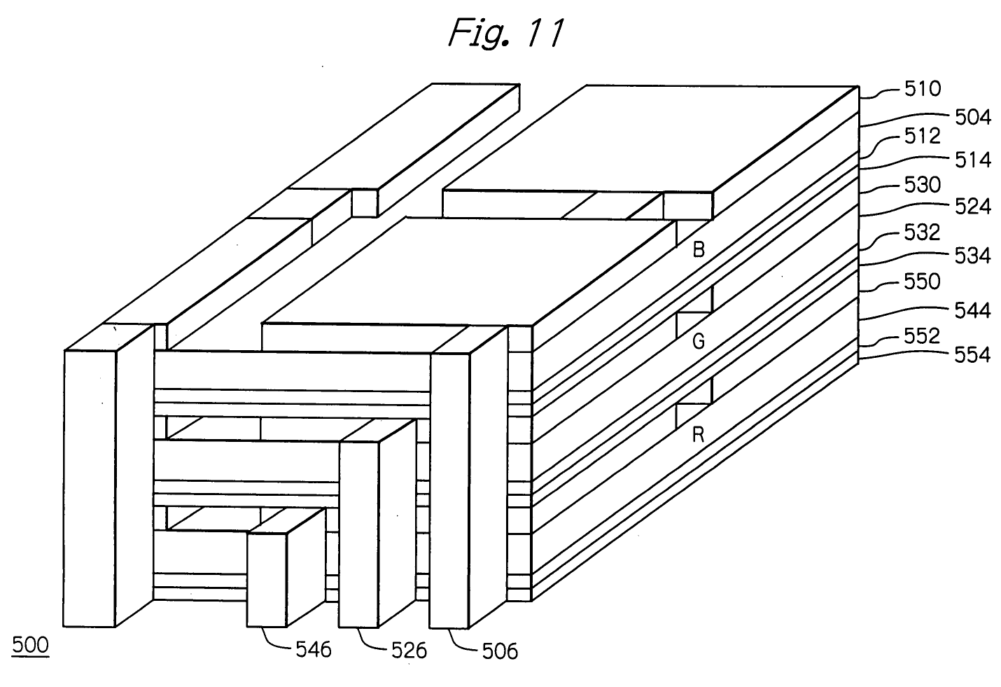

In FIG. 10, the photosensitive films 504 through 544, stacked on the photosensitive array 500, are divided on a pixel basis. Alternatively, as shown in FIG. 11, division or separation may be made not to the photosensitive films 504 through 544 but the electrode structure on a pixel basis for thereby separating the pixels. Further, each pixel of the photosensitive array 500 may not be provided with a color filter or a microlens.

The red, or third from the top in the figure, photosensitive layer 544 of the photosensitive array 500 may be replaced with a photosensitive layer that absorbs three primary colors, i.e., white, if desired. It is to be noted that the blue, green and red photosensitive layers 504 through 544, sequentially stacked in this order from the light incidence side, may be stacked in any more effective order.

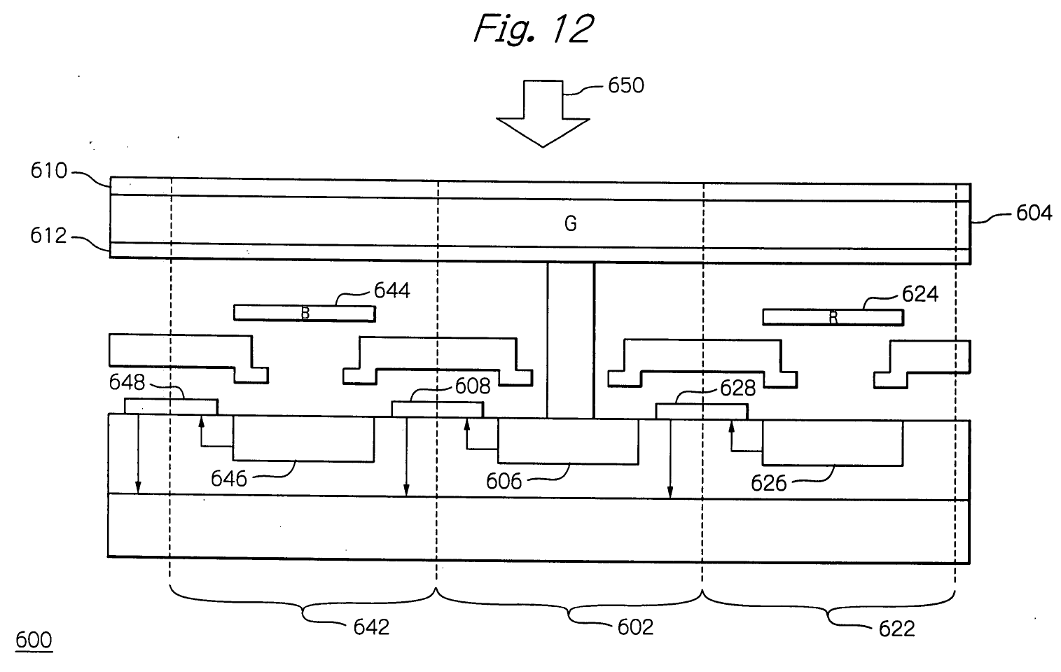

FIG. 12 shows another specific configuration of the photosensitive array. As shown, the photosensitive array, labeled 600, includes a green photosensitive, or green absorbing, film 604 positioned at the light incidence side, a red filter 624 and a photosensitive cell 626 positioned below the green photosensitive film 604 and a blue filter 644 and a photosensitive cell 646 also positioned below the film 604, constituting a green pixel 602, a red pixel 622 and a blue pixel 642, respectively. Again, although a great number of pixels are, in practice, arranged on the photosensitive array 600, FIG. 12 shows only the green pixel 602, red pixel 622 and blue pixel 642 for the simplicity of illustration.

In the configuration shown in FIG. 12, light 650 incident on the photosensitive array 600 is first input to the green photosensitive layer 604 and has a green component thereof absorbed thereby. As a result, a signal charge corresponding to the green component is generated in the green photosensitive layer 604. The remaining portion of the light 650 is then, in the similar way, incident to the photosensitive cells 626 and 646 via the red filer 624 and blue filter 644, respectively, so that signal charges each corresponding to a red or a blue component are generated in the photosensitive cells 626 and 646, respectively. In this manner, data of three primary colors are attainable with the photosensitive array 600, too.

If desired, the green absorbing film 604 maybe replaced with a single photoelectric conversion layer of any other color. For example, when the single layer is a red photosensitive layer, photosensitive cells are positioned to form a green and a blue pixel or, when the single layer is a blue photosensitive layer, photosensitive cells are positioned to form a green and a red pixel. It is also possible to replace photosensitive cells with red, blue and green absorbing films arranged in a single layer in the directions of rows and columns in a G stripe, RB full-checkerboard pattern, honeycomb G square, RB full-checkerboard pattern or similar conventional pattern.

If desired, the photosensitive array may be implemented by a stack of two photoelectric transducer films. For example, photoelectric transducer films of two different colors may be stacked in two different layers, in which case a photosensitive cell for photoelectrically converting the remaining color component will be positioned. Alternatively, to omit photosensitive cells, photoelectric transducer films of two different colors may be arranged in a single layer in the directions of rows and columns, in which case photoelectric transducer films of the remaining color will be positioned in another layer. Even in the case of a photosensitive array on which photoelectric transducer films are stacked in two layers, there may be used more effective one of various combinations of three primary colors, layers and photosensitive cells.

As stated above, by stacking photoelectric transducer films for forming pixels, it is possible to enhance efficient use of incident light and an aperture ratio without resorting to microlenses for thereby obtaining high-sensitivity images. In addition, because each layer has its particular spectral characteristic, there can be reduced false colors without resorting to color filters.

In summary, it will be seen that the present invention provides a solid-state image pickup apparatus having the following various unprecedented advantages.

When a signal representing an image picked up is output from a plurality of sections divided, a correction pixel region produces a plurality of signals varying stepwise and representative of a particular amount of incident light each. It is therefore possible to output a gradation pattern even in an environment in which a subject dedicated for correction is absent, and use correction information derived from the gradation pattern for correcting the divided sections of an image. This is successful to free an image from discontinuity ascribable to a boundary between the divided sections of the image. In addition, accurate correction is achievable even when, e.g., amplifiers included in the apparatus vary in characteristic due to varying temperature.

A storage time controller, included in the apparatus, controls the read-out of signal charges from the correction pixel region with a plurality of films varying in transmissivity stepwise in accordance with the distance from a valid pixel region or with a plurality of storage period of times varying in length. Therefore, a gradation pattern can be output even in an environment in which a subject dedicated for correction is absent.

While shooting is repeated a plurality of times in a light-shielded condition, a dark current is stored over a plurality of storage times varying every shot stepwise. As a result, a gradation pattern, constituted by dark currents, is produced to promote accurate correction in dark fields where discontinuity is apt to be conspicuous.

In the case where the storage time controller controls the read-out of signal charges in the correction pixel region with a plurality of storage times, shooting is performed only once to store a dark current over a plurality of storage times in a light-shielded condition, thereby producing a gradation pattern constituted by dark currents.

Even in the correction pixel region, color data representative of any one of a plurality of colors is generated in each pixel, so that correction information data are produced color by color in each divided section included in the correction pixel region. The correction information data are used to correct valid pixel data generated in each divided section color by color. This successfully corrects linearity on a color basis for thereby more effectively correcting a divided image.

The entire disclosure of Japanese patent application Nos. 2004-313452 and 2005-283902 filed on Oct. 28, 2004 and Sep. 29, 2005, respectively, including the specifications, claims, accompanying drawings and abstracts of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A solid-state image pickup apparatus comprising:
an image sensor for outputting an image signal with pixels formed by photosensitive cells for photoelectric conversion arranged in horizontal and vertical directions to constitute a photosensitive array; and
signal processing circuitry for processing the image signal;
said image sensor having a plurality of sections into which the photosensitive array is divided in the horizontal or vertical direction;
said image sensor comprising a corresponding plurality of output circuits each for transferring and outputting an image signal generated in particular one of the plurality of divided sections via a vertical transfer path or a horizontal transfer path;
each of said plurality of output circuits outputting particular one of a plurality of valid image signals representative of a field picked up by said photosensitive array and derived from particular one of said plurality of divided sections;
said photosensitive array producing a signal level corresponding to a predetermined quantity of light incident thereto, said photosensitive array producing a correction information signal having a plurality of stepwise levels representative of different quantities of incident light, the correction information signal being generated in each of said plurality of divided sections;
said signal processing circuitry comprising:
a plurality of divided signal processors, each of said plurality of divided signal processors being assigned to particular one of said plurality of divided sections for executing analog processing on the valid information signal and the correction information signal derived from corresponding one of said divided sections, and then converting a processed analog signal to a corresponding digital signal; and
a digital signal processor for receiving a plurality of digital valid image signals and a plurality of digital correction information signals from said plurality of divided signal processors to produced a single digital image signal from the plurality of valid image signals, and further executing digital signal processing on the single digital image signal;
said digital signal processor comprising a correcting circuit for correcting, before production of the single digital image signal, the plurality of valid image signals with the plurality of correction information signals.

2. The apparatus in accordance with claim 1, wherein said correcting circuit uses one of the plurality of correction information signals as a reference correction information signal, produces correction information for correcting the other correction information signal to a level of the reference correction information signal, and corrects one of the valid image signal corresponding to the other correction information signal with the correction information.

3. The apparatus in accordance with claim 2, wherein said correcting circuit executes, when producing the correction information, linearity correction on the reference correction information signal and the other correction information signal, detects a plurality of predetermined subject signal levels out of the other correction information subjected to linearity correction, detects a reference signal level out of the reference correction information signal in accordance with a quantity of incident light from which the plurality of subject signal levels are detected, and produces a difference between the reference signal level and the subject signal level as the correction information,
said correcting circuit detecting, when correcting the valid pixel information corresponding to the other correction information signal, the subject signal levels close to signals of the valid pixel signal among the plurality of subject signal levels, and correcting the valid pixel information with correction information corresponding to the subject signal levels detected.

4. The apparatus in accordance with claim 1, wherein said photosensitive array of said image sensor comprises a valid pixel region for generating the plurality of valid pixel signals, a correction pixel region for generating the plurality of correction information signals,
said correction pixel region being positioned at one side of said photosensitive array,
said plurality of divided sections being positioned side by side in a direction perpendicular to a boundary between said correction pixel region and said valid pixel region,
said correction pixel region having pixels arranged in parallel to the boundary for receiving an even quantity of light incident thereto.

5. The apparatus in accordance with claim 4, wherein said correction pixel region comprises a film for controlling light to be incident on the pixels of said correction pixel region,
said film having a same optical transmissivity in the direction parallel to the boundary and varying stepwise in the direction perpendicular to said boundary, whereby the plurality of stepwise signal levels are produced.

6. The apparatus in accordance with claim 4, wherein sad image sensor further comprises a storage time controller for controlling a storage time over which a signal charge is stored in each pixel of said correction pixel region and said valid pixel region,
said storage time controller reading out signal charges from the pixels with the storage time, the storage time being equal in the parallel direction and varying in accordance with a position in the vertical direction for thereby producing the plurality of stepwise signal levels.

7. The apparatus in accordance with claim 1, further comprising a shutter for selectively intercepting the light to be incident on said image sensor;
said image sensor producing, while maintaining the shutter in a closed position, a signal level caused by a dark current from each photosensitive cell over each of a plurality of stepwise storage times, whereby a plurality of stepwise signal levels caused by the dark currents are produced as the correction information signal.

8. The apparatus in accordance with claim 5, further comprising a shutter for selectively intercepting light to be incident on said image sensor;
said image sensor producing, while maintaining the shutter in a closed position, a signal level caused by a dark current, a plurality of stepwise signal levels caused by the dark currents in said correction pixel region as dark-current correction information signals via said film,
said image sensor producing a plurality of stepwise signal levels caused by light currents by opening said shutter, in said correction pixel region as light-current correction information signals via said film,
said signal processor producing the correction information signal from the dark-current correction information signals and the light-current correction information signals.

9. The apparatus in accordance with claim 6, further comprising a shutter for selectively intercepting light to be incident to said image sensor;
said image sensor producing a signal level caused by a dark current while maintaining said shutter in a closed position,
said storage time controller controlling the storage time of a signal charge in each pixel to thereby produce a plurality of stepwise signal levels caused by dark currents as the correction information signal.

10. The apparatus in accordance with claim 4, wherein said image sensor produces, in each pixel of said photosensitive array, color data representative of one of a plurality of colors and having a signal level corresponding to incident light, and produces, in each divided section of said correction pixel region, the correction information signal for each of the plurality of colors,
said correcting circuit using the correction information signals produced for each of the plurality of colors to correct the valid image signal of each of said divided sections color by color.

11. The apparatus in accordance with claim 10, wherein the plurality of colors comprise three primary colors consisting of red, green and blue.

12. The apparatus in accordance with claim 10, wherein the plurality of colors comprise complementary colors.

13. The apparatus in accordance with claim 11, wherein each of said divided sections of said correction pixel region comprises a red pixel zone, a green pixel zone and a blue pixel zone,
said red pixel zone having a plurality of red pixels arranged for producing red data to produce a plurality of stepwise red signal levels constituted by the red data,
said green pixel zone having a plurality of green pixels arranged for producing green data are to produce a plurality of stepwise green signal levels constituted by the green data,
said blue pixel zone having a plurality of blue pixels arranged for producing blue data to produce a plurality of stepwise blue signal levels constituted by the blue data,
the plurality of stepwise red signal levels, the plurality of stepwise green signal levels and the plurality of blue signal levels being used as the correction information signals of the corresponding colors.

14. The apparatus in accordance with claim 13, wherein said red pixel zone, said green pixel zone and said blue pixel zone are arranged in said divided sections of said correction pixel region in the direction perpendicular to the boundary between said correction pixel region and said valid pixel region.

15. The apparatus in accordance with claim 13, wherein said red pixel zone, said green pixel zone and said blue pixel zone are arranged in said divided sections of said correction pixel region in a direction perpendicular to a boundary between said divided sections.

16. The apparatus in accordance with claim 10, wherein each pixel of said correction pixel region is provided with a color filter having one of a plurality of colors, whereby the correction signals of the respective colors are generated.

17. The apparatus in accordance with claim 10, wherein photoelectric transducer films, each absorbing a light component of any one of the plurality of colors, are stacked on said photosensitive array to thereby form the pixels such that each pixel produces color data representative of one of the plurality of colors, whereby the correction information signals of the respective colors are generated in said correction pixel region.

18. The apparatus in accordance with claim 17, wherein the photoelectric transducer films are stacked in three layers.

19. The apparatus in accordance with claim 17, wherein the photoelectric transducer films are stacked in two layers.

20. The apparatus in accordance with claim 17, wherein said photoelectric transducer films are stacked in a single layer.

21. The apparatus in accordance with claim 20, wherein the photoelectric transducer films stacked in a single layer and said photosensitive cells are combined to form the pixels.
